(19) United States
(12) Patent Application Publication
(10) Pub. No.: US 2018/0227390 A1
(43) Pub. Date: Aug. 9, 2018

(54) APPARATUS FOR INTERFACING BETWEEN INFORMATION CENTRIC NETWORKS (ICNS) AND INTERNET PROTOCOL (IP) NETWORKS

(71) Applicant: IDAC HOLDINGS, INC., Wilmington, DE (US)

(72) Inventors: Alexander Reznik, Pennington, NJ (US); Dirk Trossen, London (GB); Xavier De Foy, Kirkland (CA)

(73) Assignee: IDAC HOLDINGS, INC., Wilmington, DE (US)

(21) Appl. No.: 15/506,432

(22) PCT Filed: Aug. 28, 2015
(86) PCT No.: PCT/US2015/047473

§ 371 Date: Feb. 24, 2017

Related U.S. Application Data
(60) Provisional application No. 62/043,700, filed on Aug. 29, 2014.

(51) Int. Cl. H04L 29/08; H04L 29/06

(52) U.S. Cl. CPC H04L 67/327; H04L 69/08; H04L 45/3065; H04L 67/02; H04L 67/2842

(57) ABSTRACT

Network nodes are described. A network node includes a transmitter, a receiver and a processor. The transmitter transmits at least one signal advertising the network node as the source of at least one specific content located outside of an information centric network (ICN) or a specific domain or all content located outside of the ICN. The receiver receives a request, from a requesting device, including an identifier for a piece of content for which the at least one signal advertised the ICN as the source of. The processor, in conjunction with the transmitter and the receiver, determines a forwarding rule for the request based at least on the identifier included in the request, forwards the request based on the determined forwarding rule, receives the piece of content, and forwards the received piece of content to the requesting device. The network node may be a Border Gateway translating between ICN and IP networking.

### CROSS REFERENCE TO RELATED APPLICATIONS

This application is the U.S. National Stage, under 35 U.S.C. § 371, of International Application No. PCT/US2015/047473 filed Aug. 28, 2015, which claims the benefit of U.S. Provisional Application No. 62/043,700, which was filed on Aug. 29, 2014, the contents of which are hereby incorporated by reference herein.

### BACKGROUND

Current Internet Protocol (IP)-based networking architecture is built around communications between a pair of machines (e.g., hosts). The hosts are assigned well-defined addresses, and the intermediate networking nodes (e.g., routers) are configured to route packets to a destination by determining a suitable next hop based on the destination IP address and the router configuration. The IP-based approach to networking has been successful. From its roots as a Defense Advanced Research Projects Agency (DARPA) project in the 1970s, this approach had, by the early 2000s, evolved to form the single fundamental component of virtually all of the world's data networks.

### SUMMARY

Network nodes are described. A network node includes a transmitter, a receiver and a processor. The transmitter transmits at least one signal advertising the network node as the source of at least one specific content located outside of an information centric network (ICN) or a specific domain or all content located outside of the ICN. The receiver receives a request, from a requesting device, including an identifier for a piece of content for which the at least one signal advertised the ICN as the source of. The processor, in conjunction with the transmitter and the receiver, determines a forwarding rule for the request based at least on the identifier included in the request, forwards the request based on the determined forwarding rule, receives the piece of content, and forwards the received piece of content to the requesting device.

In an embodiment, a network node includes a processor, a transmitter and a receiver. The processor and transmitter indicate the network node as the supply of content located inside of an ICN. The receiver receives a request, from a requesting device outside of the ICN based on an internet protocol (IP) address of the network node, including an identifier for a piece of content for which the processor and the transmitter indicated the network node as the supply of. The processor, in conjunction with the transmitter and the receiver and in response to receiving the request issues an ICN request inside the ICN for the piece of content corresponding to the identifier, receives the requested piece of content from the ICN, and forwards the received piece of content using an appropriate protocol.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a signal diagram of an example basic information centric networking (ICN) exchange format for content request and delivery; and

FIG. 3 is a block diagram of an example hybrid ICN and internet protocol (IP) system;

FIG. 4 is a flow diagram of an example method of anchoring content located outside of an ICN network with a border gateway (BGW) and receiving and forwarding requested content; and

FIG. 5 is a flow diagram of an example method of anchoring content located inside of an ICN network with a BGW and receiving and forwarding requested content.

### DETAILED DESCRIPTION

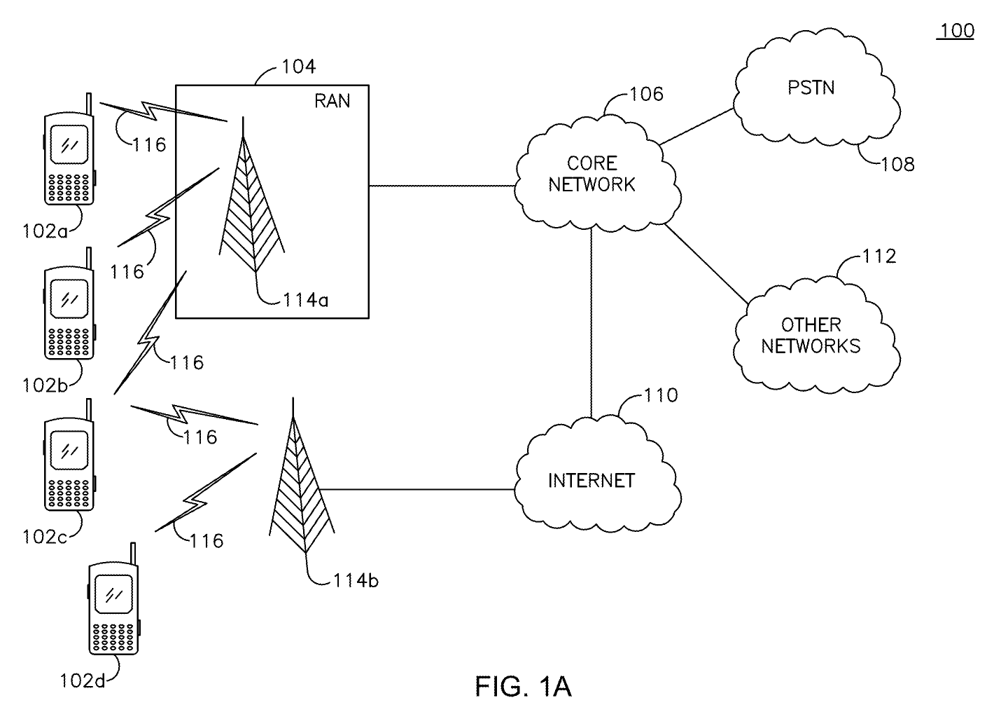

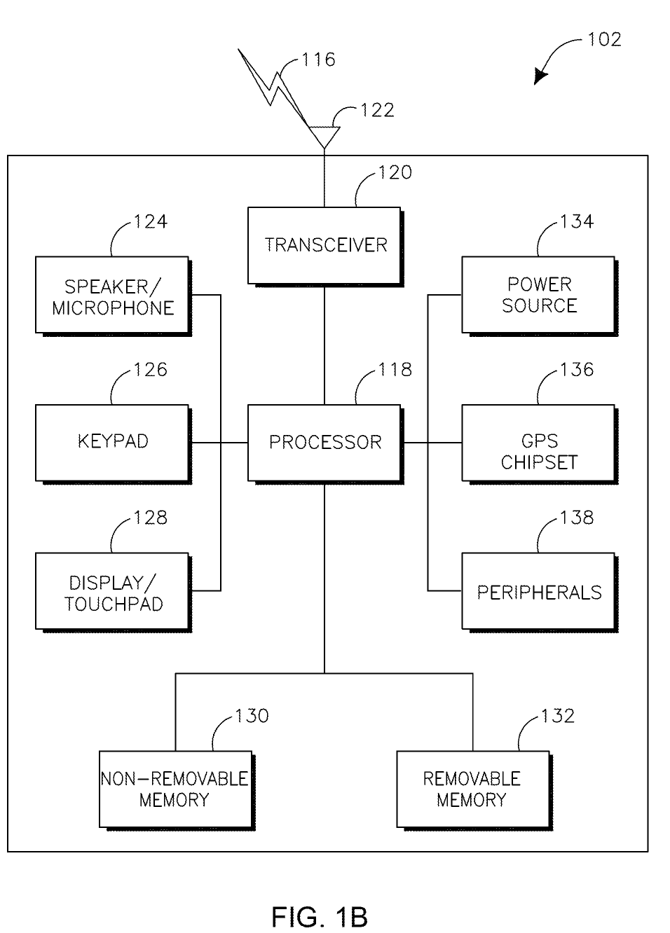

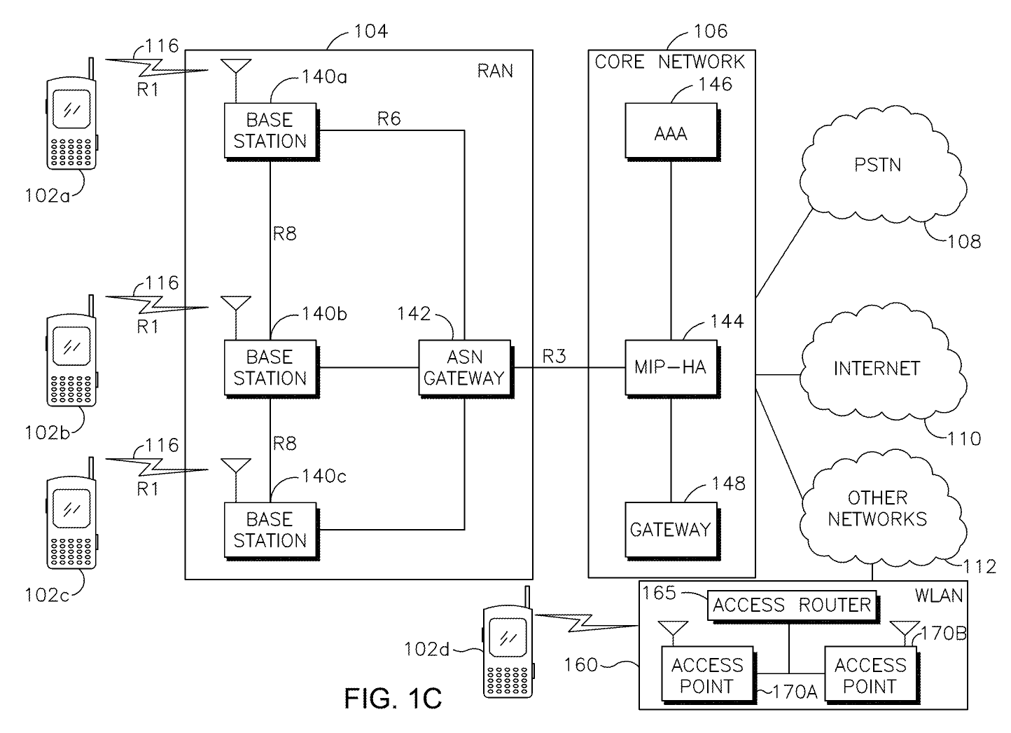

FIG. 1A is a diagram of an example communications system 100 in which one or more disclosed embodiments may be implemented. The communications system 100 may be a multiple access system that provides content, such as voice, data, video, messaging, broadcast, etc., to multiple wireless or wired users. The communications system 100 may enable multiple users to access such content through the sharing of system resources, including wireless or wired bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Alternatively, the communication system may be any wired communication system that includes a plurality of communication nodes (not shown).

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGA) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1C, the RAN 104 may include base stations 140a, 140b, 140c, and an ASN gateway 142, though it will be appreciated that the RAN 104 may include any number of base stations and ASN gateways while remaining consistent with an embodiment. The base stations 140a, 140b, 140c may each be associated with a particular cell (not shown) in the RAN 104 and may each include one or more transceivers for communicating with the WTRUs 102a, 102b, 102c over the air interface 116. In one embodiment, the base stations 140a, 140b, 140c may implement MIMO technology. Thus, the base station 140a, for example, may use multiple antennas to transmit wireless signals to, and receive wireless signals from, the WTRU 102a. The base stations 140a, 140b, 140c may also provide mobility management functions, such as handoff triggering, tunnel establishment, radio resource management, traffic classification, quality of service (QoS) policy enforcement, and the like. The ASN gateway 142 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 140a, 140b, 140c may be defined as an R8 reference point that includes protocols for facilitating WTRU handovers and the transfer of data between base stations. The communication link between the base stations 140a, 140b, 140c and the ASN gateway 215 may be defined as an R6 reference point. The R6 reference point may include protocols for facilitating mobility management based on mobility events associated with each of the WTRUs 102a, 102b, 100c.

As shown in FIG. 1C, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 144, an authentication, authorization, accounting (AAA) server 146, and a gateway 148. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 144 may provide the WTRUs 102a, 102b, 102c with access to packet-switched networks, such as the Internet 110, to facilitate communications between the WTRUs 102a, 102b, 102c and IP-enabled devices. The AAA server 146 may be responsible for user authentication and for supporting user services. The gateway 148 may facilitate interworking with other networks. For example, the gateway 148 may provide the WTRUs 102a, 102b, 102c with access to circuit-switched networks, such as the PSTN 108, to facilitate communications between the WTRUs 102a, 102b, 102c and traditional land-line communications devices. In addition, the gateway 148 may provide the WTRUs 102a, 102b, 102c with access to the networks 112, which may include other wired or wireless networks that are owned and/or operated by other service providers.

Although not shown in FIG. 1C, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

Other network 112 may further be connected to an IEEE 802.11 based wireless local area network (WLAN) 160. The WLAN 160 may include an access router 165. The access router may contain gateway functionality. The access router 165 may be in communication with a plurality of access points (APs) 170a, 170b. The communication between access router 165 and APs 170a, 170b may be via wired Ethernet (IEEE 802.3 standards), or any type of wireless communication protocol. AP 170a is in wireless communication over an air interface with WTRU 102d.

Historically, the host-to-host communication paradigm was a good match for users' communication needs, which typically involved two-way communication sessions (e.g., calls) or accessing information from a well-known location (e.g., a file server on a local area network (LAN) or file transfer protocol (FTP) site). However, with the advent of the Web as the primary application for IP-based networking, this has changed. In contrast to two way communication sessions, Web-based users typically request a specific piece of information (e.g., by specifying its uniform resource identifier (URI)) rather than a particular computer and expect the network will deliver it from any appropriate location. The requested content or information may be collected in chunks from one or more locations. And in most cases, the user does not know whether or not the chunks originate from the same location. Accordingly, the host-to-host communication paradigm may not be as good a match for most web-based computing tasks.

The process of delivering requested information or content using Web-based communication may be more efficient if information is collected from multiple sources. For example, in-network caching may be used to take advantage of nearby stores that may not be known to the user. Such multi-point-to-point communication may be built around the name of the information the user is interested in, not the address of some particular network node. In addition, while the name uniquely identifies a specific piece of information, it may refer to any of multiple copies of that information.

The need for information-based-retrieval has been addressed with overlay solutions, most notably hypertext transfer protocol (HTTP)-based approaches. Essentially, the underlying IP-based network is fully retained and a URI-based infrastructure is built on top of it that acts as if it were a name-based network.

While such overlay solutions may be sufficient, the approach is inherently inefficient, as evidenced, for example, by the process for retrieving a particular piece of content: www.example.com/my_example_pic.jpg. According to the process, a user may request www.example.com/my_example_pic.jpg by clicking on it in a browser, and then the user's browser may be tasked with finding the machine on which the requested piece of content is located. To do so, the user's browser may resolve www.example.com using the Domain Name Server (DNS) by sending www.example.com to a centralized database, which may return an IP address (e.g., 128.127.126.125) known to be the location of the machine known as www.example.com. The user's browser may send a request (e.g., by sending an HTTP GET) for my_example.jpg to 128.127.126.125. If the example.com web server at 128.127.126.125 realizes that it is not the best location to service this user with this content (e.g., it does not have the content), the web server may re-direct the user to another URL where it knows the content may be found. This process may be repeated, potentially several times. For example, if the owner redirects to a content delivery network (CDN), the first request may be to a centralized CDN management system, which may then re-direct to the actual location of the content. In the meantime, the content may actually be located right along the path of these requests, but currently there may be no way (or at least no natural and reasonable way) for the network to determine this and act on such a determination since the network may be composed of routers.

Information Centric Networking (ICN) is an emerging paradigm in data networking that aims to fundamentally reshape how networks deliver content and address the inefficiencies inherent in overlay approaches. A fundamental goal of ICN is to introduce name-based networking so that information may be requested by name, and the network entities (e.g., ICN routers) may make decisions based on routers.

For example, in contrast to the process for retrieving a particular piece of content, in an ICN network, a user may request www.example.com/my_example_pic.jpg by clicking on it in a browser. In response, the browser may issue an ICN INTEREST for www.example.com/my_example_pic.jpg. An ICN ROUTER receiving such an interest may forward it on or service it locally (if it has the content cached). An ICN router may forward the content, and the content may be delivered in chunks. In a baseline ICN approach, it may be up to the user's device (e.g., the browser) to integrate the chunks, although the intermediate routers may also serve this function.

The ICN network procedure is more efficient in that, for example, it requires significantly fewer exchanges and allows the network to optimize how content is provided to a client (and does so dynamically). Instead of being locked into to particular service points based on the initial DNS resolution, the ICN procedure may, for example, respond to changes in network and traffic conditions and take advantage of in-network content distribution.

Notwithstanding the potential advantages of an ICN-based approach to content delivery over the traditional HTTP-overlay, actual deployment of an ICN-based approach would require either a complete change in network software and hardware as well as a change in client equipment or at least the gradual upgrade of single networks to ICN-based networking. The emergence of software defined networking (SDN) as a widely supported technology in commercial networking hardware may allow for the introduction of ICN-based (e.g., IP overlay or non-IP) networking technologies within a single network using a gradual upgrade and deployment approach with both traditional and ICN-based network protocols and management deployed within the same network side-by-side. In other words, a network may be internally upgraded toward support of ICN using a gradual, low-cost and low-risk software upgrade with ICN and legacy software coexisting for a very long time. However, the internally upgraded ICN network will exist side by side with many IP networks. Accordingly, changes to networks may also need to be made to enable the ICN and legacy software to communicate with one another. Embodiments described herein may address the handling of ICN network requests for IP content and IP network requests for ICN content in such hybrid networks.

A protocol for handling requests for content in hybrid ICN/IP systems may include two phases: a registering content phase and a content request and delivery phase. The registering content phase may include informing relevant parties in the system of the availability and location of content. Execution of the registering content phase may be heavily implementation dependent. For example, if ICN is implemented using HTTP, the registering content phase may simply include registering the domain name with the DNS. Similarly, in Mobility First, the registering content phase may include registering the global universal identifier (GUID) with the global name resolution service (GNRS), and in PURSUIT, the explicit PUBLISH methods may need to be sent to the rendezvous system to make information identified through a directed acyclic graph identifier available to others. On the other hand, for content-centric networking (CCN), the procedure for the registering content phase may be more implicit and may include updating the forwarding information bases (FIBs). In embodiments described in more detail below, a network node may be employed, such as the border gateway (BGW) that sits on the edge of a network, and the registering content phase may include registering non-ICN content at the network node for the ICN network and registering ICN content at the network node for the non-ICN network.

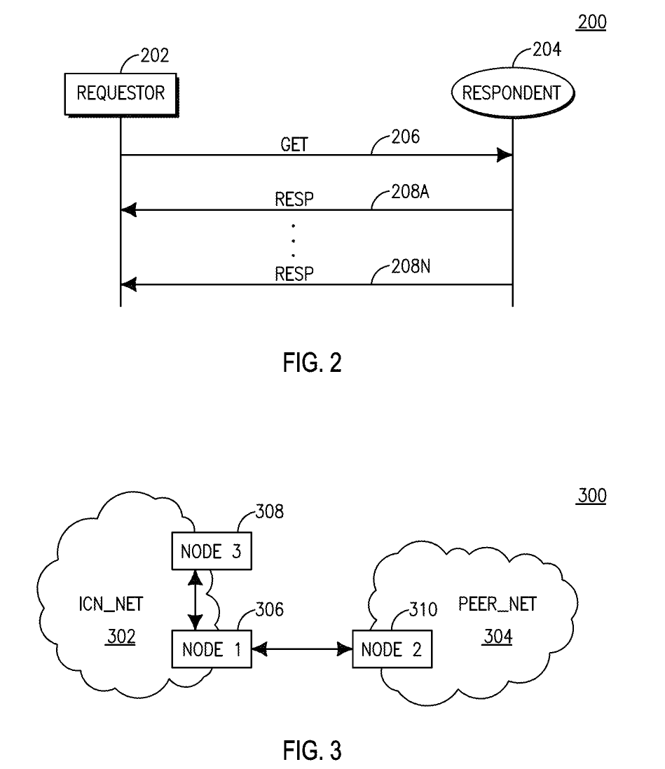

FIG. 2 is a signal diagram 200 of an example basic ICN exchange format for the content request and delivery phase. In the illustrated example, the content and delivery phase makes use of two types of a messages that may be exchanged between a Requestor 202 and a Respondent 204 (e.g., requesting and responding entities configured with a respective one of an ICN or IP protocol). The Requestor 202 may make a request for content or may make some other type of request, such a content location lookup request or a content setup request. A GET message 206 may be used to encode all types of requests. The Respondent 204 may respond using one or more RESPONSE message 208a-n. The one or more RESPONSE messages 208a-nmay carry all or a portion of the actual content payload. If the GET message 206 is for a request that is not for actual content, the one or more RESPONSE messages 208a-n may carry the result, such as OK for a setup request, the result for a lookup request, or one or more error codes. In the illustrated example, a single GET message 206 results in more than one RESPONSE messages 208a-n, each of which may carry a chunk of the requested content. This may help manage retrieval of large pieces of content.

The simple GET/RESPONSE structure described above with respect to FIG. 2 may make ICN networks highly flexible. In a single GET/RESPONSE exchange, the Requestor 202 is not necessarily the entity looking for the content. Similarly, the Respondent 204 is not necessarily the actual content server. Either or both of the Requestor 202 or the Respondent 204 may, for example, be intermediate network nodes acting on behalf of other nodes. For example, the GET message 206 may be issued in response to receiving a GET message from another network entity.

While the exact structure of the GET and RESPONSE messages will be highly dependent on the ICN implementation, possible fields that may be included in an example GET message 206 may include a CONTENT ID field, a REQUEST ID field, an ORIGIN ID field, a CONTENT REQUESTOR ID field, a TIMESTAMP field or an ADDITIONAL METADATA field. The CONTENT ID field may include an identifier of the requested content. The identifier itself, however, may depend on the nature of the ICN structure employing the GET request message and may, for example, be a name (e.g., a URI), a hash that may be uniquely mapped to the content (e.g., a GUID), a layered and/or ontologically structured identifier that may either be fully resolved to a content name or resolved to a network in which the content resides. The CONTENT ID field will usually be a required field.

The REQUEST ID field may include an identifier for the particular request. The REQUEST ID field may not be strictly required but will very likely be included in most implementations and may be very helpful for practical protocol implementations. The ORIGIN ID field may include a network identifier for the entity making the request. While the REQUEST ID field may not be strictly required, it will likely be included because it may be helpful to properly forward the responses. In most implementations, either the REQUEST ID field or the ORIGIN ID field will be required. Without at least one of the two pieces of information, it may not be possible to forward the response with the requested content back to the requestor 202. In many implementations, both the REQUEST ID and ORIGIN ID fields will be included in the GET message 206.

The CONTENT REQUESTOR ID field may be an optional field that identifies the ultimate source of the content request. Unlike the ORIGIN ID field, the CONTENT REQUESTOR ID field may not correspond to the actual GET in which it is located. In fact, it may be a list resulting from an intermediate node aggregating multiple requests. In some implementations, the CONTENT REQUESTOR ID field may not be needed because it would always correspond to the ORIGIN ID. The TIMESTAMP field may technically be an optional field, but many implementations are likely to use a timestamp to prune stale requests from the network.

The CONTENT PROPERTIES field may be a required field that may provide key information about the content being requested. Such properties may include a TYPE (e.g., audio, video, or HTML), a FORMAT, an APPLICATION PROTOCOL (e.g., key information about the protocol that may be in use, such as RTP or CoAP). The ADDITIONAL METADATA field may include additional information about the request and may provide context (e.g., where the request is made, what kind of device made the request, or application name) as well as information required for routing the request (e.g., to the IP network).

The one or more RESPONSE messages 208a-n may include similar fields. For the one or more RESPONSE messages 208a-n, the CONTENT ID field may include an identifier of the content that is included in the payload. The CONTENT ID field may not be required in the RESPONSE message, however, because the content ID may also be obtained by matching it with the REQUEST ID. A CHUNK ID field may be included in a RESPONSE message and may be required. It may denote which chunk of a total content the particular communication represents. The REQUEST ID field may include an identifier of the request to which the RESPONSE message is responding. One of the REQUEST ID field or the CONTENT ID field may be required because it may not be possible to forward a response (e.g., requested content) back to the Requestor 202 without one of the two pieces of information. In many implementations, both the REQUEST ID and the CONTENT ID field may be required.

The ORIGIN ID field may include a network identifier for the entity making the request. The CONTENT REQUESTOR ID field may be an optional field that identifies the ultimate source of the content request, similar to the CONTENT REQUESTOR ID field described above with respect to the GET message 206. As with the GET message 206, the TIMESTAMP field in the RESPONSE message 206a-n may be useful in pruning stale responses and selecting an appropriate response from duplicates. The CONTENT PROPERTIES field may be a required field and may be similar to the CONTENT PROPERTIES field described above with respect to the GET message 206. The ADDITIONAL METADATA field may include additional information about the content and may provide context about the content itself. The ADDITIONAL METADATA field in the RESPONSE message 208a-n may include different information from the ADDITIONAL METADATA field in the GET message 206 because it may, in the RESPONSE message 208a-n, provide context about the content as opposed to context about the request.

As described in further detail below, embodiments described herein may make use of one or more network nodes to exchange communications between ICN and IP network entities. The one or more network nodes may sit at the edge of one or more of the ICN and IP networks. In an embodiment, the one or more network nodes may be border gateways (BGWs).

FIG. 3 is a block diagram of a hybrid ICN and IP system 300. In the illustrated example, the system 300 includes an ICN network (ICN-NET) 302 and an IP network (PEER_NET) 304. Network nodes 306 and 308 are located at the edge of ICN_NET 302, and network node 310 is located at the edge of PEER_NET 304. In an embodiment, one or more of the network nodes 306, 308 and 310 may be BGWs and are referred to herein as BGWs. However, it should be understood that the network nodes may be any suitable network node.

A BGW is a functional entity, which resides at the edge of a network and may perform functions associated with routing and forwarding data between points inside the network associated with the BGW and other networks. As such, the BGW may communicate with entities inside the associated network and other BGWs outside the associated network. In IP networks, a border gateway protocol (BGP) may be used to accomplish BGW tasks. BGWs may also perform functions associated with inter-network operation, such as network address translation (NAT) or firewall.

In the example illustrated in FIG. 3, ICN_NET 302 includes BGW 306, and PEER_NET 304 includes BGW 308, which may communicate with each other for purposes of inter-network communication. The example ICN_NET 302 includes an additional BGW 308 to highlight the possibility of internal routing and/or forwarding. In this scenario, the BGW 308 may be responsible for interactions with some other external networks that are not illustrated.

In the embodiments described herein, the network node or BGW may be provided with the additional functionality of anchoring content requests in the BGW (where necessary) and translating between ICN and IP networking. In the example system 300 illustrated in FIG. 3, translation may be performed by either BGW 306 or 310, but not both. If BGW 310 performs the translation, then BGW 306 is a pure legacy BGW. For purposes of clarity in describing the embodiments below, it may be assumed that anchoring and translation are performed by BGW 306. However, all of the embodiments described herein remain essentially the same if the functionality is moved to any other one of the BGWs in the system 300 (or any hybrid system).

In an embodiment, an entity in an ICN network requires content that is located in an IP-based network. In the registration of content phase, content located in the IP-based network may be anchored at the BGW so that requests from the ICN network may actually arrive at the BGW. The relevant content to be anchored at the BGW may be one or more specific pieces of content not located in the ICN network or all content not residing in the ICN network. To anchor content to the BGW, supply of the relevant content should occur before the demand for it occurs (e.g., before a request for the content is issued). The BGW may advertise itself as the source of content located outside of the ICN network, for example, by sending one or more messages (e.g., REGISTER messages) to at least one entity in the ICN network.

The BGW may indicate itself as the source of content on an individual basis where a specific content located in the IP network is advertised with the location of the BGW as its supply. This may be desired, for example, where tight external content access control is desired (e.g., for enterprise environments). This may be referred to as an explicit whitelisting approach. In an embodiment, the explicit whitelisting approach may be aggregated at the level of entire domains or even top-level domains (TLDs). In this embodiment, content of entire organizations residing on an IP network may be made available in the ICN network.

Alternatively, the BGW may indicate itself as the supply for any content not located in the ICN network by establishing itself as a default location for any content not found in the ICN network. This may be referred to as a default route approach. For the default route approach, an appropriate CONTENT ID may be assumed to be used with the nature of the appropriate CONTENT ID depending on the identifier scheme being used in the ICN network. For example, in CCN, a wildcard name may be used, compliant with the naming scheme used in CCN, which may be hierarchical and include a domain as the root element.

For another example, in a PURSUIT-like architecture, a special security identifier (SID) or relative identifier (RID) may be used to identify any content not located in the ICN network, while a special GUID may be used in MobilityFirst-like embodiments. In this example, each SID or RID may essentially be a fixed-length identifier pointing to a particular level in a hierarchical naming structure. The higher levels of this hierarchy (which result in SIDs) may need some level of global coordination (similar to the way domain names are coordinated in the Web). The lower levels (which result in RIDs) may be private to any network. This may be analogous, for example, to path names that may follow domain names in retrieving particular content using HTTP. A PURSUIT router may advertise itself as a rendezvous point for a name at any level in the hierarchical naming architecture. Accordingly, the BGW may advertise itself as the rendezvous point for the external SIDs that it services. By doing so at an appropriate level, it may automatically encompass all content with IDs within that particular sub-tree of the naming hierarchy. A similar approach may be used by a BGW for URL or domain-name-based ICN implementations (e.g., that use URLs but do not resolve them to IP addresses). The BGW may simply advertise itself as the rendezvous point for the sub-set of domains that it addresses by advertising the proper domain names.

In a CCN, anchoring may be performed using forwarding information basis (FIB) entries to indicate the supply for a particular CONTENT ID. The FIB entry may point to the local network interface where the content may be found. This may, in turn, result in a similar forwarding at the next CCN element. The FIB entries for all ICN network components (e.g., CCN routers) may need to point, ultimately, to the appropriate BGW. In an embodiment, adapted open shortest path first (OSPF) approaches may be used to calculate the appropriate route across the ICN network.

If an explicit whitelisting approach is used, an explicit set of FIB entries may be created for each whitelisted CONTENT ID. This may be done either at once (if the whitelist is static and a-priori known) or dynamically every time the whitelist changes. If the whitelisting occurs at an aggregate level, in CCN, the used hierarchical namespace may allow for appropriate aggregating such non-ICN-network CONTENT IDs (e.g., per domain or even TLD) and may point the FIB entries to the appropriate BGW that connects to the appropriate IP network that may serve the whitelisted content.

If a default route approach is chosen, a set of FIB entries for the wildcard CONTENT ID may be calculated, and the CCN routers may need extension by falling back to the wildcard FIB entry if no other match has been found in the FIB of the specific CCN router.

ICN architectures, such as MobilityFirst or PURSUIT, use a name or identifier resolution system referred to as rendezvous for matching the demand for content with its supply. In an embodiment, the resolution system may be informed that the BGW is the supplier for any relevant content.

If an explicit whitelisting approach is used, the BGW may signal the supply of content for each whitelisted CONTENT ID. Aggregation may be performed in architectures such as PURSUIT by the appropriate BGW subscribing to the appropriate SID or RID sub-space representing the name space for which the BGW is responsible. For example, if a domain *.youtube.com was translated in a specific SID or RID structure (using, for example, a simple hash-based hierarchical SID or RID sub-space), the BGW serving the YouTube namespace may indicate availability of content by publishing the SID/RID structure to the rendezvous system. Therefore, any ICN network request within this namespace may receive the BGW location as a result.

If a default route approach is used, the BGW may signal a wildcard to the rendezvous system with the BGW indicated as the location of supply. Rendezvous systems of existing ICN architectures may equal the supply for this wildcard through the BGW as an indication that any request for content that cannot be otherwise satisfied should be sent to the wildcard location (i.e., the BGW) as a default alternative instead of returning an error that the content was not found. The result of the match for any IP network content may instead return the registered BGW location as a result.

An HTTP-based ICN architecture may more closely follow an explicit rendezvous solution. Here, an explicit demand/supply matching may be performed at the ICN-enabled Web Proxy, forwarding the request toward the destination. In this case, the decision protocol in the Web Proxy may take into account the relevant content indications received from the BGW, similar to a stand-alone rendezvous system. The web proxy may implement a similar albeit localized rendezvous system as realized by the PURSUIT architecture, and the BGW may apply the same methods described above with respect to the PURSUIT architecture to indicate the supply of IP network content to the web proxy. The web proxy may then perform a local (rendezvous) match for any incoming content, and, for IP network content, the request may be redirected to the appropriate BGW.

Once the supply of content is anchored to the BGW, the content request and delivery phase may occur. In this scenario, and ICN GET message may arrive at the BGW 306, for example, from another entity inside the ICN network. Upon receipt of the request, BGW 306 may first need to determine where to forward the request next. In particular, it may forward it to another ICN-based network node (e.g., BGW 308) based on a purely ICN forwarding rule.

In order to properly route content requests, an ICN BGW should support two routing capabilities: an ICN capability and a IP-based capability. On a condition that an ICN BGW receives a GET request, it may use the CONTENT ID and, in some embodiments, the CONTENT PROPERTIES, to look up an ICN-based forwarding rule for the request. The ICN-based forwarding rule may point to the BGW itself when the BGW has content caching capability and the requested content is known to be in its cache. If an ICN route exists for the request and is preferred based on routing rules, then it is taken. Otherwise, the BGW may proceed to check for an IP based route. When checking for an IP-based route, the BGW may first check whether a destination IP address for content location is known or can be computed locally. For example, the BGW may make a mapping between the content name and destination IP addresses, or the GET request may include a location IP address, for example, as part of the Metadata.

If the IP address is not known, the BGW may look it up. For example, the BGW may look up the IP address using DNS lookup based on domain name. For some ICN implementations, such as when ICN is an extension of HTTP, the Domain Name may be explicitly provided or may be inferred from the Content ID. For example, if URIs are used for ICN, the Domain Name may be part of the URI. If ICN protocols are built as an extension of HTTP using GET and HTTP Response messages, then the Domain name may be explicitly stated within HTTP GET as a host name. For another example, the BGW may look up the IP address using a content-focused name resolution service, such as the global name resolution service (GNRS).

Once the IP address is known, the BGW may determine what external IP network communication this IP address is to be routed through. This may be done using existing IP methods. In an embodiment, the BGW may use BGP and act as a BGP BGW to look up the autonomous system number (ASN) for the destination network (PEER_NET in FIG. 3, for example).

As an example, the ICN system may be implemented by using or extending HTTP. In such an embodiment, the GET request may have the following format (with a fictitious HTTP version of ICN.1 used instead of actual 1.1):

GET/index.html HTTP/ICN.1

Host: www.example.com

In this example, the BGW may derive the full CONTENT ID (URI) www.example.com/index.html and determine that the CONTENT ID does not have an ICN-based forwarding path. The BGW may then derive the domain name www.example.com and determine that it cannot associate an IP address with this domain name locally. The BGW may then use DNS by initiating a DNS session to look up the IP address for www.example.com. For example, if the DNS session returns 10.0.0.1, the BGW may perform a BGP lookup on 10.0.0.1 to associate it with an ASN 100, which is the ASN of the IP network (e.g., PEER_NET).

As another example, the BGW may use RTSP to request real-time (e.g., streaming) content to be delivered using RTP from an ICN Network. In the simplest form of this process, the BGW may receive a GET message that includes the following RTSP request: <COMMAND> rtsp://example.com/media.mp4/streamid=0 RTSP/1.0, where COMMAND is one of a number of RTSP commands. For purposes of the BGW, this may be treated as just another request because it includes a valid CONTENT ID rtsp://example.com/media.mp4/streamid=0. The BGW may convert this to a valid IP address and then to an ASN using the same process described above with respect to HTTP.

Once the BGW has established that the request should be forwarded to an IP network (e.g., to IP address 10.0.0.1 routed via the Peer_NET network with ASN 100 in the above examples), the BGW may generate the actual IP packets (or sequence of packets) that will carry the request. The procedure that the BGW will use may depend on whether an IP socket with the destination exists.

On a condition that no IP socket exists with the destination, which will be the case in the majority of situations, the destination (e.g., at IP 10.0.0.1) has not yet been contacted with the request and is probably not aware that a request is forthcoming. Because the destination is an IP host (IP server), it may expect an IP session (a socket) to be established with it. The BGW may initiate the establishment of such a session using, for example, TCP or UDP, as appropriate for the application context associated with content. The BGW may be the originator of the request (i.e., it may present itself as the request originator to the server at 10.0.0.1). The process of establishing the connection may generate IP packets at the BGW with a destination IP address 10.0.0.1. These may be routed to the IP network (e.g., Peer_NET) since this destination address may be associated with the PEER_NET ASN.

In the HTTP-based ICN example described above, the BGW may now open an internal socket for a connection to IP 10.0.0.1 using TCP port 80 and the HTTP request as a payload and converting the request into a proper HTTP format. In the simple example described above, the version number was simply replaced with a valid HTTP version 1.1:

GET/index.html HTTP/1.1

Host: www.example.com

To handle the response, the BGW may maintain a database, which may include the following information:

| | | |
|---|---|---|
| Socket Info | Content ID | Requesting Entities List |

In the above example database, the Socket Info may be the IP address, transport protocol (e.g., TCP or UDP) and port number that would normally be associated with a socket. The Content ID field may include the ID of the content for which the socket was opened. The Requesting Entities List may be a list of entities that requested the content. Given that the Requesting Entities List is a list of ICN entities, the ICN may efficiently service multiple requests for the same content using a single content fetch, which, in this case, corresponds to a single IP request and a single socket. While the Socket Info and Content ID fields may be fixed once a socket is opened, the Requesting Entities List may be continually updated as more requests come in.

As the responses come in, the BGW may accumulate the payloads, re-assembling the required content if necessary. It may also initiate other requests if required (e.g., if an HTTP re-direct response comes in). Once the content is fully ready, the BGW may forward it to all the requestors in the Requesting Entities List using an appropriate ICN protocol.

On a condition that the IP client has an established socket, the Client has already opened up a TCP or UDP port over which it expects to accept a communication session. The BGW should be cognizant of the port and the IP address of the client as it accepts data responses from the session.

As an example, RTSP/RTP-based sessions for streaming real-time content may be used. In the simplest possible RTSP session, the Client may issue two requests: SETUP and PLAY. Example SETUP and PLAY sessions with requests and responses are provided below:

Setup:

| | |
|---|---|
| C->S: | SETUP rtsp://example.com/media.mp4/streamid=0 RTSP/1.0 |
| | CSeq: 3 |
| | Transport: RTP/AVP;unicast;client_port=8000-8001 |
| S->C: | RTSP/1.0 200 OK |
| | CSeq: 3 |
| | Transport: RTP/AVP;unicast;client_port=80008001;server_port=9000- |
| | 9001 |
| | Session: 12345678 |

Play:

| | |
|---|---|
| C->S: | PLAY rtsp://example.com/media.mp4 RTSP/1.0 |
| | CSeq: 4 |
| | Range: npt=5-20 |
| | Session: 12345678 |
| S->C: | RTSP/1.0 200 OK |
| | CSeq: 4 |
| | Session: 12345678 |
| | RTPInfo:url=rtsp://example.com/media.mp4/streamid=0;seq=1; |
| | rtptime=2 |

If this exchange were to be originated within the ICN network (e.g., by an ICN Client) and targeted to an IP-based server, then the SETUP request may cause the lookup operation in the BGW. Once the lookup is complete, the BGW may open up a TCP socket to the RTSP server and manage the exchange. The server may use the BGW's IP address to forward the actual media (RTP) traffic to. The BGW may be configured to accept RTP traffic and forward it into to the client using ICN-based protocols. In an embodiment, this may be done without fully assembling the content first.

However, in some cases, the client may want to accept its traffic directly using an RTP-based IP connection. For example, it may open up UDP ports 8000 and 8001 (in the example) and expect traffic from server ports 9000-9001 as directed in the response. To support this operation, the BGW may accept SETUP and PLAY requests from the client transmitted using ICN protocols and forward these to the server through appropriate RTSP configuration (e.g., opening up port 554). It may forward responses back to the client using appropriate ICN protocols.

To support appropriate forwarding of the actual media traffic, the BGW may act as a proxy between the client and the server, accepting media (RTP) traffic from the server over a connection as expected by the server and then forwarding the traffic to the client over a separate connection. While this may allow the BGW to act independently of other functions (e.g., NATs), it may also introduce additional processing and delay into the media delivery process.

An alternative approach may be for the BGW to act in concert with the IP-network NAT/firewall sub-system, which may determine how the IP traffic traversing the boundary of the network is handled. Because a BGW may be co-located with these functions, the solution may be a natural one. Upon receiving an RTSP Setup request from the client, the BGW may communicate with the NAT and obtain the IP address and port number to which the client's IP address and port numbers are to be mapped. As an alternative, the BGW/NAT sub-system may select a single IP address for all RTSP sessions with port 554 traffic mapped to BGW and other (random) port assignments, as is usual for a NAT, for actual client RTP traffic.

Once the BGW knows the external IP address and external ports associated with the client, it may modify the client's requests (SETUP and PLAY as well as other RTSP requests) so that the port numbers correspond to the external port numbers as defined by the NAT. Moreover, the BGW may use the external IP address assigned to the Client (or the common selected external IP address) for RTSP traffic to/from the server.

The firewall may be configured to allow through traffic (based on IP address/port number) for legitimate media sessions. This may allow the actual media traffic to flow directly to the client(s) using traditional IP-based protocols while taking advantage of the ICN network for session setup and management.

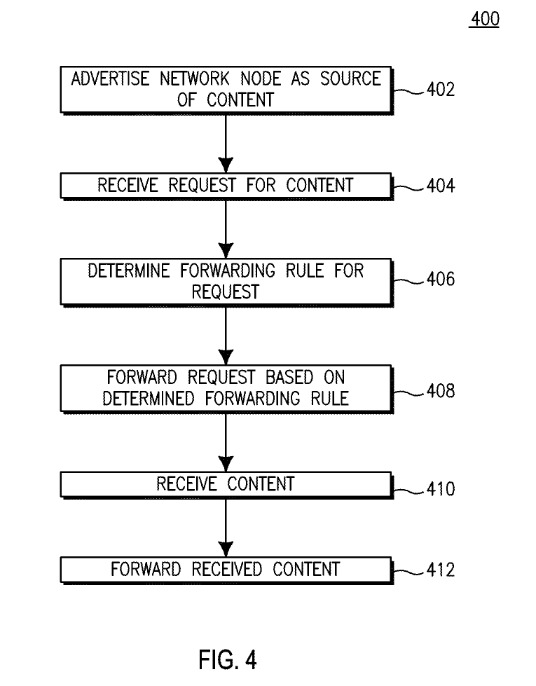

FIG. 4 is a flow diagram 400 of an example method of anchoring content located outside of an ICN network with a BGW and receiving and forwarding the requested content. In the example illustrated in FIG. 2, a network node advertises itself as the source of at least one specific content located outside of the ICN or a specific domain or all content located outside of the ICN (402). The network node may advertise itself of the source of the content by, for example, transmitting at least one signal advertising itself as the source of the content. The network node may be a node in any type of wireless or wired network.

The network node may receive a request for content (404). This may be a request, from a requesting device, that includes an identifier (e.g., CONTENT ID) for a piece of content for which the at least one signal advertised the ICN as the source of. The network node may then determine a forwarding rule for the request, for example, based at least on the identifier included in the request (406), forward the request based on the determined forwarding rule (408), receive the piece of content (410) and forward the received piece of content to the requesting device (412).

The requesting device may be configured for an ICN protocol, and the content may be located in an internet protocol (IP) network. The at least one signal transmitted by the transmitter may include at least one of a wildcard name compliant with a CCN naming scheme; a SID or a RID for any content not located within the ICN; a GUID; an advertisement of the network node as the rendezvous point for external SIDs that the network node services; an advertisement of the network node as the rendezvous point for a sub-set of domains that the network node addresses; or one or more FIB entries pointing to the network node.

The forwarding rule may be determined by searching for an ICN-based forwarding rule for the received request based at least on the identifier included in the request. On a condition that the ICN-based forwarding rule is not found as a result of the searching, the network node may determine at least one of whether an IP address for the content is known or whether the IP address for the content can be computed locally. On a condition that the IP address for the content is not known and cannot be computed locally, the network node may search for the IP address for the content. The network node may search for the IP address for the content by performing DNS lookup based on a domain name that is indicated by the request.

The network node may forward the request by determining whether an IP socket exists. On a condition that the network node determines that the IP socket does not exist, it may initiate establishment of an IP session with a server. The ICN network node may be presented to the server as the originator of the request. The network node may then open an internal socket connection, convert the request into proper format for transmission to the server, and update a database to include information about the socket for use in routing retrieved content to the requesting device. On a condition that it is determined that the IP socket exists, the network node may accept media traffic from a server over a connection, as expected by the server, and forward the media traffic to the requesting device over a separate connection. Alternatively, on a condition that it is determined that the IP socket exists, the network node may obtain an IP address and port number to which an IP address and a port number of the requesting device are mapped and modify the request so that port numbers correspond to the obtained port number.

In another embodiment, an entity in an IP-based network requires content that is located in an ICN network. In the registration of content phase, content located in the ICN network may be anchored at the BGW so that requests from the IP-based network may actually arrive at the BGW. In this case, the BGW may act as an IP-enabled device toward the IP network (e.g., PEER_NET) in terms of the content request. Indicating supply in this case very much depends on the particular protocol being used for the content request. In the most common content request cases, the CONTENT ID would be a URL with HTTP being the main content transport protocol. Alternatives for the transport may be RTSP or RTP for streaming content, using a URL for content identification again.

In both cases, the BGW may indicate that the content hosted in the CONTENT ID is located behind the BGW. For a URL naming scheme, the DNS is one way to match the demand for content (e.g., the HTTP request sent from the PEER_NET) with the supply (e.g., the BGW being a proxy for accessing the content). Hence, the BGW may need to indicate to the DNS that any content in ICN_NET is located (from an IP perspective) at the BGW. The entity operating the ICN network may select an appropriate top-level domain name and create a DNS record for the top level domain as a CNAME and/or DNAME record (the exact choice may depend on the specifics of the ICN network design), which it may register with the DNS system. Both a CNAME and a DNAME record may point to an actual domain name. The actual domain name may have its own separate DNS record with which an IP address is associated (an A record or an AAAA record). The A/AAAA record may be for a sub-domain of the top-level DNAME or CNAME. The ICN system may select such an appropriate sub-domain and create an appropriate DNS record for it as well. The IP address of this DNS record may be the IP address of the appropriate BGW.

Upon request for content in the ICN network, the DNS server of the IP network may recognize the CNAME/DNAME portion of the URL (for example cnn.com may be the DNAME for all cnn.com domains). The record may then be used to look up the appropriate A/AAAA record, eventually leading to the IP address of the appropriate BGW.

To load-balance the system, requests for a particular top-level domain may need to be spread across several BGWs. Technologies such as round-robin DNS may be used to achieve this and may be further enhanced to select one of the several BGWs associated with a top-level domain in a randomized fashion, for example, based on the hash of the full content name (URL).

A more flexible approach toward directing the IP-client toward the appropriate BGW (and therefore toward load-balancing) may be to allow the ICN network itself to select the BGW based on criteria additional to the URL. The Client device may send a DNS request example.icnnet.com (where icnnet is the top-level domain name associated with the ICN network). The DNS server authoritative for icnnet.com may select the appropriate BGW (in its domain) based on some criteria. One example of a selection criteria may be to have the DNS in icnnet.com do a reverse IP lookup to determine the domain where the IP client resides (e.g., it is local.org). It may then select the BGW (in the icnnet.com domain) based on the REQUESTOR's LOCAL DOMAIN field, which it may receive in the DNS request. Another example may be to have the DNS requestor include additional information, such as location, in the request, which may be used in selecting a BGW. Another example may be to take the BGW loading into account and use BGW selection as a load balancing tool.

In another embodiment, the Client device may send a DNS request example.icnnet.com (where icnnet is the top-level domain name associated with the ICN network). The DNS server authoritative for icnnet.com may perform a reverse IP lookup to determine the domain where the IP client resides (e.g., it is local.org), and perform a CNAME redirection to example.icnnet.com.icn.local.org. It may concatenate the following into a new FQDN to perform a lookup on <REQUESTED_ICN_FQDN>.<REQUESTOR'S LOCAL_DOMAIN>. The DNS resolver (e.g., the client's DNS resolver) may receive the response with the CNAME and send another request with the pointed name. The DNS server on the local domain may receive the query and perform special processing because it is under icn.local.org. This processing may basically select the proper border gateway that should act as a front end for ICN_NET.

In an explicit whitelisting approach, the BGW may issue DNS registration requests to the DNS that point a particular URL to its own IP address. This explicit whitelisting may happen at different levels of the DNS naming scheme and, therefore, allow for some form of aggregation, such as at the domain or sub-domain level. A default route solution, however, may not be possible since such wildcard may be not supported in the DNS, and it may be assumed that more than one ICN_NET may exist worldwide, creating the possibility for ambiguity as to which ICN_NET content is meant in case the content is not found in any IP-based PEER_NET.

Once the DNS resolution at the IP-based client in the PEER_NET has successfully returned the IP address of the BGW of the ICN_NET, the content request forwarding may take place. Once the CONTENT ID is registered to the BGW, the BGW may simply become the proxy server for whatever the content is (e.g., Web Proxy for HTTP, RTP forwarding node for RTP, etc.). It has a public IP address, so NATs may not be an issue. It may issue an appropriate ICN request inside the ICN network, gather the content, and forward it using the appropriate protocol.

To improve overall network operation, load balancing across BGWs may be necessary. For example, the different BGWs may support different protocols (e.g., one BGW may be an HTTP proxy while another may be an RTP or RTSP proxy, etc.). Such a selection may be done by selecting different URLs and/or FQDNs. Alternatively, load balancing may be achieved by balancing across requestor domain or using randomization.

For certain protocols, most notably HTTP, load balancing may also be achieved through application level re-direction. Thus, for example, the contact BGW may be any BGW using round-robin DNS, and then the BGW may redirect to another BGW based on actual content.

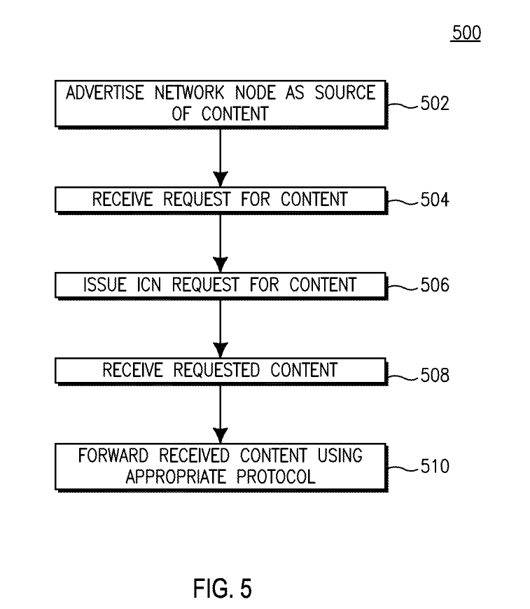

FIG. 5 is a flow diagram 500 of an example method of anchoring content located inside of an ICN network with a BGW and receiving and forwarding the requested content. In the example illustrated in FIG. 5, the network node advertises itself as the source of the content (502). To do so, the network node may indicate itself as the supply of content located inside of an ICN. The network node may receive a request for content (504). In an embodiment, the network node may receive the request from a requesting device outside of the ICN based on an IP address of the network node. The request may include an identifier for a piece of content for which the processor and the transmitter indicated the network node as the supply of. The network node may then issue an ICN request inside the ICN for the piece of content corresponding to the identifier (506), receive the requested piece of content from the ICN (508), and forward the received piece of content using an appropriate protocol (510). The network node may be a node in any type of wireless or wired network.

The requesting device may be configured for an IP protocol and, in an embodiment, may be a DNS. The identifier included in the request (e.g., CONTENT ID) may be a URL, and the appropriate protocol may be one of HTTP, RTSP or RTP. The supply of the content may be indicated by registering one of a CNAME or a DNAME corresponding to the content with the DNS server.

Although features and elements are described above in particular combinations, one of ordinary skill in the art will appreciate that each feature or element can be used alone or in any combination with the other features and elements. For example, many of the features and elements are described above with respect to a wireless network, it will be appreciated that many of the features and elements may also be implemented within a wired network. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A network node comprising:
a transmitter configured to transmit at least one signal advertising the network node as the source of one or more pieces of content located outside of an information centric network (ICN) or a specific domain;
a receiver configured to receive a request, from a requesting device located inside the ICN or the specific domain, including an identifier for a piece of content of the one or more pieces of content for which the at least one signal advertised the network node as the source; and
a processor configured to, in conjunction with the transmitter and the receiver:
make a determination regarding a forwarding rule for the request based at least on the identifier included in the request,
forward the request based on the determination regarding the forwarding rule,
receive the piece of content, and
forward the received piece of content to the requesting device.

2. The network node of claim 1, wherein the requesting device is configured for an ICN protocol.

3. The network node of claim 1, wherein the piece of content is located in an internet protocol (IP) network.

4. The network node of claim 1, wherein the at least one signal transmitted by the transmitter includes at least one of a wildcard name compliant with a content-centric networking (CCN) naming scheme; a security identifier (SID) for any content not located within the ICN: or a relative identifier (RID) for any content not located within the ICN; a globally unique identifier (GUID); an advertisement of the network node as the rendezvous point for one or more external SIDs that the network node services; an advertisement of the network node as the rendezvous point for a sub-set of domains that the network node addresses; or, one or more forwarding information base (FIB) entries pointing to the network node.

5. The network node of claim 1, wherein the determination further includes:
searching for an ICN-based forwarding rule for the received request based at least on the identifier included in the request,
condition that the ICN-based forwarding rule is not found as a result of the searching, determining at least one of whether an IP address for the content is known or whether the IP address for the content can be computed locally, and
on a condition that the IP address for the content is not known and cannot be computed locally, searching for the IP address for the content.

6. The network node of claim 5, wherein the searching for the IP address for the content comprises performing domain name system (DNS) lookup based on a domain name that is indicated by the request.

7. The network node of claim 1, wherein the processor is further configured to, in conjunction with the transmitter and receiver, forward the request by:
determining whether an IP socket exists,
on a condition that it is determined that the IP socket does not exist:
initiating establishment of an IP session with a server, wherein the network node is presented to the server as the originator of the request,
opening an internal socket connection,
converting the request into proper format for transmission to the server, and
updating a database to include information about the socket for use in routing retrieved content to the requesting device.

8. The network node of claim 1, wherein the processor is further configured to, in conjunction with the transmitter and receiver, forward the request by:
determining whether an IP socket exists, and
on a condition that it is determined that the IP socket exists:
accepting media traffic from a server over a connection as expected by the server, and
forwarding the media traffic to the requesting device over a separate connection.

9. The network node of claim 1, wherein the network node is a node in a wired network.

10. The network node of claim 1, wherein the processor is further configured to, in conjunction with the transmitter and receiver, forward the request by:
determining whether an IP socket exists, and
on a condition that it is determined that the IP socket exists:
obtaining an IP address and port number to which an IP address and a port number of the requesting device are mapped, and
modifying the request so that one or more port numbers correspond to the obtained port number.

11. A network node comprising:
a processor and a transmitter configured to indicate the network node as the supply of one or more pieces of content located inside of an information centric network (ICN); and
a receiver configured to receive a request, from a requesting device outside of the ICN based on an internet protocol (IP) address of the network node, including an identifier for a piece of content of the one or more pieces of content for which the processor and the transmitter indicated the network node as the supply of,
wherein the processor is further configured to, in conjunction with the transmitter and the receiver and in response to receiving the request:
issue an ICN request inside the ICN for the piece of content corresponding to the identifier,
receive the piece of content from the ICN, and
forward the piece of content using an appropriate protocol.

12. The network node of claim 11, wherein the requesting device is configured for an IP protocol.

13. The network node of claim 11, wherein the requesting device is a domain name service (DNS) server.

14. The network node of claim 11, wherein the identifier included in the request is a uniform resource locator (URL) and the appropriate protocol is one of hypertext transport protocol (HTTP) real-time streaming protocol (RTSP) or real-time transport protocol (RTP).

15. The network node of claim 14, wherein the processor and the transmitter indicated the network node as the supply by registering one of a canonical name (CNAME) or a delegation name (DNAME) corresponding to the content with the DNS server.

16. The network node of claim 11, wherein the network node is a node in a wired network.
